(19) United States
(12) Patent Application Publication
(10) Pub. No.: US 2025/0061758 A1
(43) Pub. Date: Feb. 20, 2025

(54) CONTROL SYSTEM FOR LABORATORY ENCLOSURE

(71) Applicant: Andrew Alliance S.A., Canton of Geneva (CH)

(72) Inventor: Giorgio Horak, Geneve (CH)

(21) Appl. No.: 18/802,144

(22) Filed: Aug. 13, 2024

Related U.S. Application Data
(60) Provisional application No. 63/519,417, filed on Aug. 14, 2023.

(51) Int. Cl. G07C 9/00; G01N 35/00

(52) U.S. Cl. CPC G07C 9/00571; G01N 35/0099; G07C 9/00896

(57) ABSTRACT

A system for controlling access to an interior of a laboratory enclosure comprises a motor in communication with an access door of the laboratory enclosure to transition the access door between an open state and a closed state, the access door exposing an opening to a work surface inside the laboratory enclosure in the open state and at least partially covering the opening in a closed state; an electronic controller that generates control signals for the motor to transition the access door between the open state and the closed state; and a software interface configured to provide a data instruction from an external computer to the electronic controller to generate the control signals and governing the movement of the access door.

### RELATED APPLICATION

This application claims priority to U.S. Provisional Patent Application No. 63/519,417 filed on Aug. 14, 2023 and titled “Control System for Laboratory Enclosure”, the entirety of which is incorporated by reference herein.

### FIELD OF THE INVENTION

The disclosed technology relates generally to laboratory automation. More particularly, the technology relates to controlling access to a laboratory enclosure and laboratory devices having an enclosed or integrated workbench.

### BACKGROUND

Conventional laboratories today are constructed and arranged to reduce workflow bottlenecks, especially where samples, reagents, or other materials stored in tubes, pipettes, and the like are transferred to and from laboratory enclosures, such as fume hoods, vertical laminar flow hoods, liquid handling automation enclosure, and the like, which typically have an access door such as a front sash that is manually opened or closed. In modern laboratories where human operators and automation systems such as robotic liquid handling systems coexist, an operator may desire to open and close an enclosure's sash in connection with an operation performed by a robotic liquid handler or other automation systems inside the enclosure, which can impose safety risks on the user while also expose the samples or reagents to external contaminants. Also, automation systems comprising robots having articulating arms and the like may move about the laboratory and operate to access an interior of an enclosure, and in doing so, may require a sash to be open. Therefore, enclosures are designed to limit user access to the interior where the automation system is located.

Modern laboratories implement automated solutions for the execution of experiments, where human operators are replaced by fixed and mobile robotic arms to transfer samples and reagents from different laboratory devices. A sash used in modern enclosures and liquid handling systems has not been designed to be opened and closed by a robotic arm, but rather by a human. The typical workaround is to keep the sash completely or partially open, which can result in problems in terms of contamination of samples and reagents to external contaminants or the safety of the users working in the same laboratory. Otherwise, a user must be readily available to manually open and close the sash as desired.

It is desirable for a laboratory door, or more specifically, a sash to be automatically controlled so that users and/or robotic apparatuses can safely access an enclosure housing an automation system such as a robotic liquid handling system.

### SUMMARY

In brief, embodiments of the present inventive concept address the need to synchronize and enable access to a laboratory enclosure and working area of an automated liquid handling system in a highly automated laboratory that relies on fixed and mobile robotic arms.

In one aspect, a system for controlling access to an interior of a laboratory enclosure comprises a motor in communication with an access door of the laboratory enclosure to transition the access door between an open state and a closed state, the access door exposing an opening to a work surface inside the laboratory enclosure in the open state and at least partially covering the opening in a closed state; an electronic controller that generates control signals for the motor to transition the access door between the open state and the closed state; and a software interface configured to provide a data instruction from an external computer to the electronic controller to generate the control signals and govern a movement of the access door between the open state and the closed state.

The laboratory enclosure may be a chemical or biological enclosure.

The access door may include a mechanical sash.

The software interface may include an application programming interface (API) that stores a security credential that may be compared to a security credential provided by the external computer to determine whether to generate the data instruction.

The system may further comprise at least one sensor that detects a position of the access door and sends position data to the electronic controller to automatically inactivate a device at the work surface when the at least one sensor detects the position of the access door between the open state and the closed state.

The software interface may receive a data request from the external computer for the access door to be opened, and the controller in response inactivates the device at the work surface inside the enclosure.

The external computer may store and execute a software scheduler that controls a synchronization between a robotic arm external to the laboratory enclosure and the access door when in the open state receives the robotic arm.

The transition from the closed state to the open state may include the electronic controller placing a device at the work surface in a pause state.

The device may be an automated liquid handling apparatus.

The device may include a device enclosure, and the electronic controller may control access to the device enclosure inside the laboratory enclosure.

The electronic controller may communicate with the device by a physical connection of the device.

The external computer may communicate with the electronic device by a software connection of the electronic device, wherein the external device may exchange the control signals between the software connection of the electronic device and the electronic controller.

In another aspect, a laboratory enclosure comprises a housing; a motor in communication with an access door of the laboratory enclosure to transition the access door between an open state and a closed state, the access door exposing an opening to a work surface inside the laboratory enclosure in the open state and at least partially covering the opening in a closed state; an electronic controller that generates control signals for the motor to transition the access door between the open state and the closed state; a software interface configured to provide a data instruction from an external computer to the electronic controller to generate the control signals and governing the movement of the access door; and an electronic device inside the housing that is controlled by the electronic controller commensurate with the open state and the closed state of the access door.

The housing may be integral with the electronic device, and the controller may place the electronic device inside the housing in a pause state to when transitioning the access door between the open state and the closed state.

The electronic device may include a device enclosure positioned in the housing, and the electronic controller may control access to the device enclosure inside the housing.

The electronic device may be an automated liquid handling apparatus.

The electronic controller may communicate with the electronic device by a physical connection of the electronic device.

The external computer may communicate with the electronic device by a software connection of the electronic device, and external device may exchange the control signals between the software connection of the electronic device and the electronic controller.

In another aspect, a laboratory device comprises a robotic liquid handling apparatus; a housing about the robotic liquid handling apparatus having an opening for access to the robotic liquid handling apparatus; an access door at the opening; a motor in communication with the access door to transition the access door between an open state and a closed state, the access door exposing an opening to the robotic liquid handling apparatus inside the housing in the open state and at least partially covering the opening in a closed state; an electronic controller that generates control signals for the motor to transition the access door between the open state and the closed state; and a software interface configured to provide a data instruction from an external computer to the electronic controller to generate the control signals and govern a movement of the access door between the open state and the closed state.

The electronic controller may receive a user request to open the access door, determine whether the robotic liquid handling apparatus is operating, place the robotic liquid handling apparatus in a pause state, and unlock the access door when the robotic liquid handling apparatus is in the pause state.

The laboratory device may further comprise an authentication system in communication with a client device that outputs the user request with a unique personal identification, wherein the electronic controller unlocks the access door in response to the authentication system processing the user request and the unique personal identification.

In another aspect, a method for controlling an access door of a laboratory enclosure comprises receiving a user request to open the access door; determining whether an electronic device inside the laboratory enclosure is operating; placing the electronic device in a pause state; and unlocking the access door when the electronic device is in the pause state.

The method may further comprise executing a locking interlock process to prevent a user generating the user request from accessing a work surface inside the laboratory enclosure by locking the access door if the electronic device is not in the pause state.

The method may further comprise processing, by an authentication system in communication with a client device generating the user request, a unique personal identification; and unlocking the access door in response to the authentication system processing the user request and the unique personal identification.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a perspective view of a laboratory enclosure having a sash controlled according to embodiments of the present inventive concept.

FIG. 2 is a block diagram of a laboratory enclosure incorporating an access door control system, in accordance with embodiments of the present inventive concept.

FIG. 3 is a flow diagram of a laboratory enclosure non-locking interlock process, in accordance with embodiments of the present inventive concept.

FIG. 4 is a flow diagram of a laboratory enclosure locking interlock process, in accordance with embodiments of the present inventive concept.

FIG. 5 is a perspective view of a laboratory enclosure in which some embodiments of the present inventive concept can be implemented.

FIG. 6 is a perspective view of a laboratory enclosure in which other embodiments of the present inventive concept can be implemented.

FIG. 7 is a perspective view of a laboratory enclosure in which other embodiments of the present inventive concept can be implemented.

FIG. 8 is a sequence diagram of a method of security for accessing a laboratory enclosure, in accordance with embodiments of the present inventive concept.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

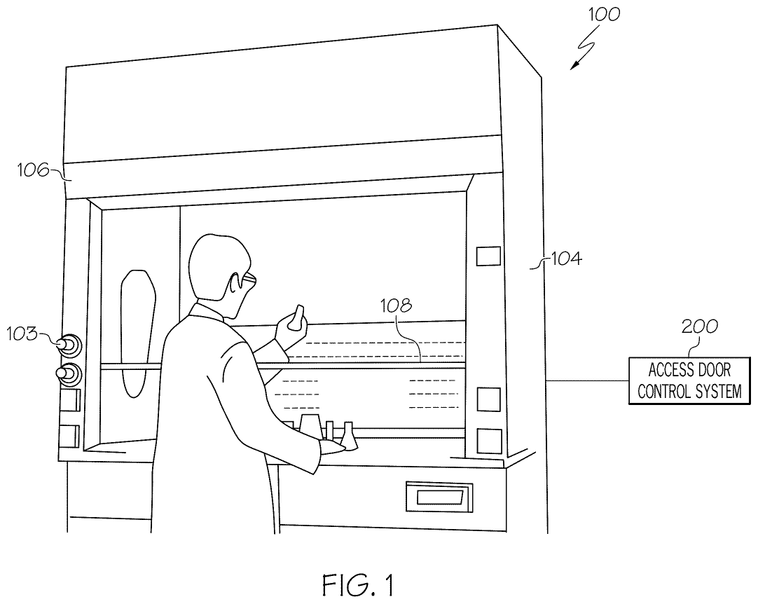

FIG. 1 is a perspective view of a laboratory enclosure 100 having a sash 102 controlled according to embodiments of the present inventive concept. The laboratory enclosure 100 can be constructed and arranged as a chemical or biological fume hood, vertical laminar flow hood, dust-proof enclosure, or safety cabinet having a work surface such as a workbench on which objects are positioned such as labware or consumables such as syringes, beakers, funnels, and test tubes constructed to hold chemicals, biological samples, reagents, and so on.

The laboratory enclosure 100 can be constructed and arranged for receiving the labware or consumables by a user such as a human operator or robot for processing inside the enclosure 100. The consumables may be held in a rack or other holder (not shown). The contents of the of the consumables may be processed, for example, centrifuging, analysis, and so on. Analysis of the contents may include liquid chromatography-mass spectrometry (LC-MS) or other analytical chemistry techniques.

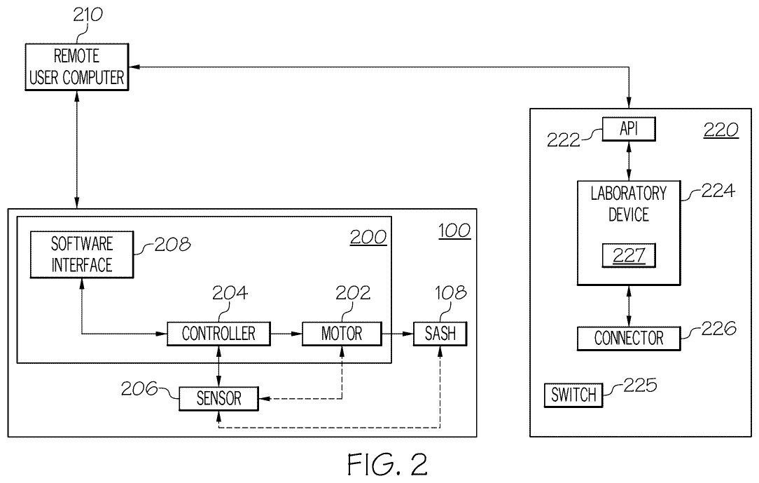

The laboratory enclosure 100 illustrated in FIG. 1 comprises a basic hood structure including a pair of end walls 104 and a front wall 106, which includes a hinged door 108 or sash that exposes a work surface 110 when the sash 108 is in an open state. In some embodiments, the sash 108 can be opened by the activation of a button 103 at the front wall 106 of the enclosure 100. In other embodiments, the sash 108 can be opened via an API or the like using a software client executed by a desktop, tablet, or smartphone computer, for example, a remote user computer 210 shown in FIG. 2, which communicates with a computer program stored at and executed by a processor or a controller (described below). In some embodiments, the sash 108 includes a hinge so that a user can lift the sash by rotating the sash 108 about the hinge. In other embodiments, sash 108 is a vertically movable sash member, shown as a transparent sliding window framed by a metal casing and allowing access to the work surface 110, while providing both containment and protection from hazardous materials. For example, when the enclosure 100 is constructed as a chemical fume hood, the enclosure 100 can offer user protection from volatile or hazardous materials. In another example, when the enclosure 100 is constructed as a vertical laminar flow apparatus, the enclosure 100 can protect samples inside the enclosure 100 from external contaminants. In another example, when the enclosure 100 is constructed as a safety cabinet, the enclosure 100 can protect both users and samples. In other applications, the enclosure 100 may protect users from possible collisions, pinches, or other undesirable or harmful interactions between a user and movable components such as a gripper of a liquid handler robot (not shown in FIG. 1) inside the enclosure 100, which can perform automated sample preparation operations or the like.

The end walls 104 and/or front wall 106 of the enclosure 100 may include displays, switches, electrical outlets, pumps, shakers, and/or other components (not shown) for controlling the operation of the enclosure 100. The enclosure 100 may also include components for controlling air flow inside the enclosure such as baffles, airfoils, fans, ventilators, exhaust stacks, and/or other air filter components. The system may include one or more mechanical or electro-mechanical switches that communicate with a motor and/or related sensors to detect the opening and closing or a sash, which in turn can be used for controlling an activation or pause state of a laboratory device such as a liquid handler inside the enclosure.

FIG. 2 is a block diagram of a laboratory enclosure 100 incorporating an access door control system 200, in accordance with some embodiments.

As shown in FIG. 2, the control system 200 includes a motor 202, an electronic controller 204, and a software interface 208, which controls the sash 108 of the enclosure 100. The enclosure 100 is generally described in FIG. 1 so details thereof are omitted for brevity. In addition to the components described in FIG. 1, the enclosure 100 can include at least one sensor 206 that communicates with the motor 202 and controller 204, which detects the position of the sash 108 during an open or closed operation. For example, a sensor 206 can be implemented to determine how many inches the sash is opened or closed.

The motor 202 is used to open and close the sash window 108 in response to commands provided from the software interface 208 and the controller 204. In some embodiments, the motor 202 includes a drive shaft or the like that is coupled to the sash window 108 that rotates to raise or lower the movable sash window 108. The motor 202 can be an electrical motor, a gasoline motor, a battery-operated motor, a pneumatic motor, DC motor, servo motor, stepper motor, linear motor, belt motor, or any other motor known to those of ordinary skill in the art. The sash 108 is coupled to the motor, which in turn is coupled to the controller 204 via one or more electrical and/or mechanical connections. The controller 204 may include a servo amplifier, motion controller, and logic that exchanges data with the software interface 208 to generate control signals for the motor 202 to move the sash 108. The controller can include a driver that is configured according to the type of motor. For example, a stepper motor requires a driver that is different from brushed or brushless motors. The controller 204, based on control signals received from the software interface, can provide instructions to the motor 202 which in turn opens and closes the sash 108. In some embodiments, an external computer communicates with an electronic device inside the housing that is controlled by the electronic controller commensurate with the open state and the closed state of the access door by a software connection of the electronic device. Here, the external device can exchange the control signals between the software connection of the electronic device and the electronic controller. The software connection may include data bits or the like that travel through wired or wireless means, such as copper wires, wireless transceivers, and so on. This operation can be controlled and/or programmed by a remote user computer 210 running a scheduler or other third party software application via the software interface 208 and controller 204. Accordingly, the motor 202 may be operated automatically by a data communication exchange between the remote user computer 210 and the software interface 208 of the control system 200, which in turn sends data instructions to the controller 204 for controlling the movement of the sash 108 according to the received instructions.

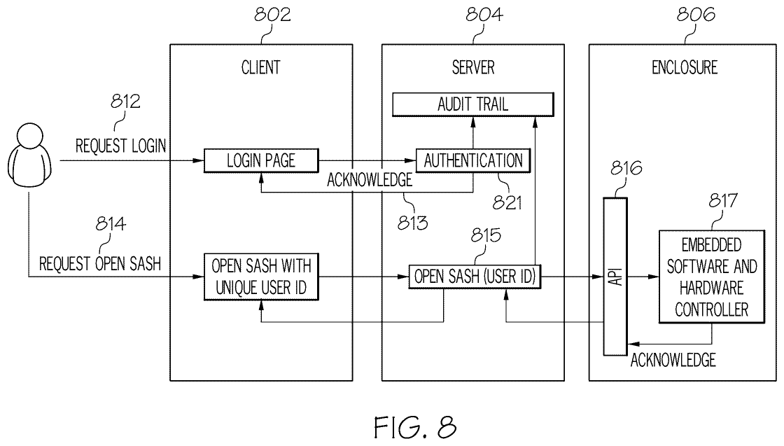

In some embodiments, the software interface 208 stores a security credential that is compared to a security credential provided by the remote user computer 210 to determine whether to generate the data instruction. The security credential can be a personal identification or the like. Therefore, particular users can be authorized to access the enclosure, for example, described with reference to FIG. 8.

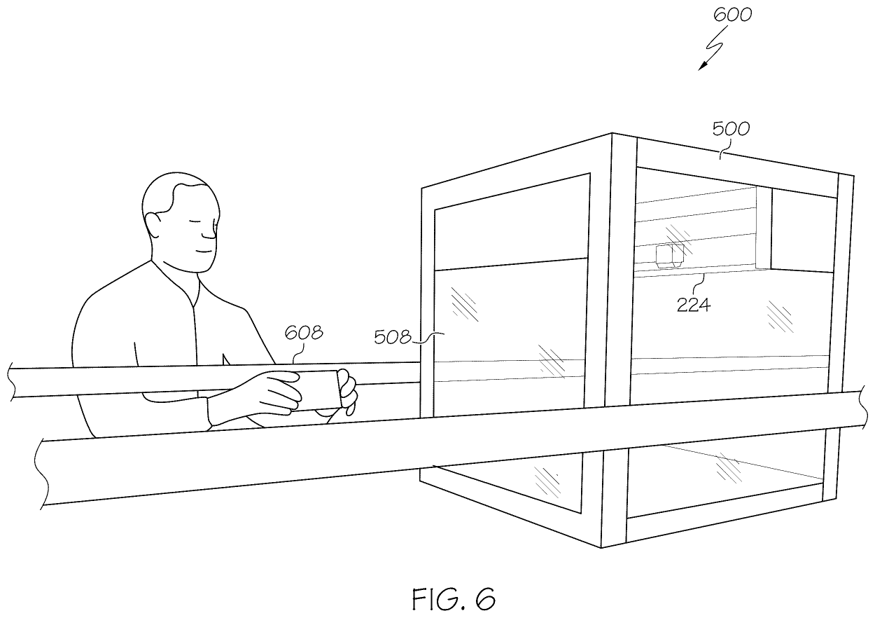

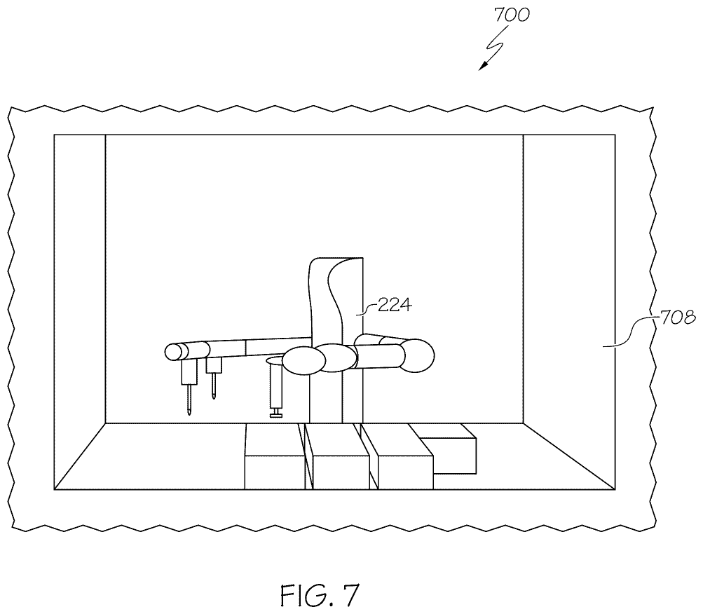

In some embodiments, a second enclosure 220 can be inside the main enclosure 100, referred to as a “first enclosure.” In some embodiments, the second enclosure 220 includes a software interface 222 such as an API, a laboratory device 224, and a physical interface 226. In some embodiments, the laboratory device 224 includes the software interface 222 and physical interface 226, for example, in the absence of a housing or separate enclosure. In some embodiments, the laboratory device 224 includes a liquid handling robot that operates inside the second enclosure 220 for automating liquid functions, also shown in FIG. 6. For example, the liquid handling robot may have a workstation robotic arm with a gripping mechanism for gripping microplates, columns, tip racks, and so on for moving them throughout the second enclosure 220 and/or a region of the main enclosure 100. In other embodiments where there is no second enclosure 220, the laboratory device 224 is a standalone apparatus and can be inside the first enclosure 100, for example, shown in FIG. 7.

In some embodiments, the software interface 222 of the laboratory device 224 in the second enclosure 220 may be part of the control system 200 and is similar to the software interface 208 of the main enclosure 100 in that it is used by a remote computer to control the operations of a sash (not shown) of the second enclosure 220. In particular, the main enclosure software interface 222 may exchange data with the remote computer 210 for controlling the sash 108, and the second enclosure software interface 222 may exchange data with the remote computer 210 for controlling an operation of the laboratory device 224. This operation can be controlled and/or programmed by a remote computer via the software interface 208 and controller 204. In some embodiments, the software interface 222 may control a sash window or the like (not shown) of the second enclosure 220 independently of the main enclosure software interface 208. In other embodiments, a single API, e.g., 208, may control both the first enclosure sash 108 and the laboratory device 224. In some embodiments, a robot or other automation system apparatus may desire to access the enclosure using a robotic arm so the sash must be in an open state. Here, a software scheduler stored at and executed by the remote computer 210 can control the synchronization between the robotic arm and the sash.

The physical connection 226 to the controller 204 can also allow communication within the laboratory device 224 and the enclosure 100 in addition to or instead of the API 222 of the laboratory device 224 and/or the enclosure software interface 208. The physical connection 226 may include an electric conduit. i.e., wire, that transmits electronic signals to and from the controller 204. In some embodiments, the physical connection includes a well-known wired or wireless network connection that communicates with a physical connection (not shown) of the controller 204 according to a network protocol. In some embodiments, a user may wish to manually open the sash. However, the sash may be locked by a locking mechanism so that the user cannot open it until the handler 224 is in a pause state.

As described above, external communications with the remote user computer 210 may occur either via communicating directly with the main enclosure software interface 208 or via the API 222 of the laboratory device 224 present inside the enclosure. The communication within the laboratory device 224 and the main enclosure 100 may be with a physical connection 226 or via API 222.

An external communication may include a request from the remote user computer 210 to close the sash 108, which is output from the external computer to the software interface 208. In response, the software interface 208 outputs a list of instructions to be performed to the controller 204. The controller 204 can verify if the sash 108 is closed by checking the status of the sensor 206, which may be homing switch, absolute or relative linear encoder, time-of-flight sensor, or other type of sensor. If the sensor 206 confirms that the sash is closed, then the controller 204 outputs the status to the software interface 208, which sends a notification of the status to the remote user computer 210.

If the sensor 206 indicates that the sash 108 is not closed, then the sensor 206 can send a notification of the status to the controller 204 which processes the instructions to be output to the motor 202 to close the sash 108. After the commands are sent from the controller 204 to the motor 202, in one embodiment the controller 204 monitors the status of the sensor 206 to verify when the sash 108 is closed. After the sensor 206 confirms that the sash 108 is closed, this information is propagated back to the remote user computer 210 via the software interface 208.

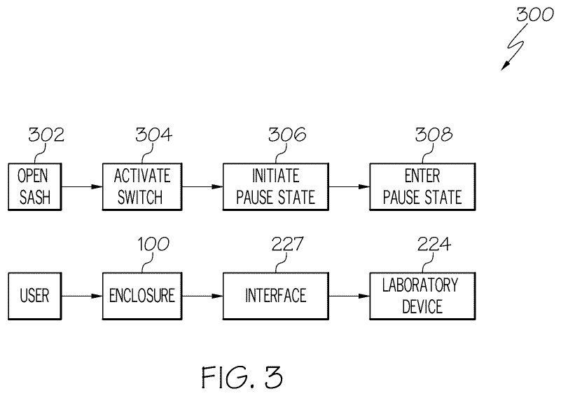

FIG. 3 is a flow diagram of a laboratory enclosure non-locking interlock process 300, in accordance with embodiments of the present inventive concept. The non-locking interlock process 300 may apply to a sash that can be opened remotely, for example, via an API using a client stored and executed at a mobile device or other remote computer, or opened by a button 103 of the enclosure 100, e.g., shown in FIG. 1. In describing the process 300, reference is made to the control system 200 that can perform some or all of the process 300. The laboratory enclosure 100 may be constructed to operate in a non-locking manner when the laboratory device 224 has no inertia. For example, when the sash is opened, a sensor 206 or the like can send signals to the controller 204 to automatically inactivate or turn off the laboratory device 224 so that it is no longer operating. Here, there is no waiting period because there is no mechanical inertia involved that would require sufficient time for the laboratory device 224 to stop operating. The non-locking interlock process 300 can be performed to prevent a user from accessing the workspace of a laboratory enclosure unless the laboratory device, e.g., liquid handler, is in a pause state where it cannot injure the user.

At block 302, a user opens the sash 108 to access the work surface 110. In some embodiments, an automation system such as an external robot may have opened the sash 108, for example, using an RFID transceiver or the like that communicates with the controller 204, e.g., via the software interface 208, which in response sends control signals to the motor to automatically open the sash 108.

At block 304, a switch 225 is activated. The switch 225 can communicate with the sash to detect movement of the sash. In doing so, when the sash is opened, the switch 225 triggers the laboratory device 224 inside the second enclosure 220, or inside the main enclosure 100 in the absence of the second enclosure 220, to enter a pause state. Accordingly, at block 306, the laboratory device 224 initiates the pause state. The enclosure-lab device interface 227 part of the laboratory device 224 and can include a special purpose computer processor that performs a translation of the external and internal instruction, for example, initialize the system to perform operations. Here, control is synchronous because the switch 225 located at the sash 108 triggers the shutting down of the device 224.

In some embodiments, the laboratory enclosure non-locking interlock process 300 can be performed where a robotic arm is used instead of a human operator. The process 300 links the laboratory enclosure to the liquid handler 224. Conventional liquid handlers embedded in a laboratory enclosure require the sash of the liquid handler to be kept open, which bypasses the security of the system. The process 300 implements an automatic procedure to place the liquid handler in a pause state when the human operator or robotic arm opens the enclosure.

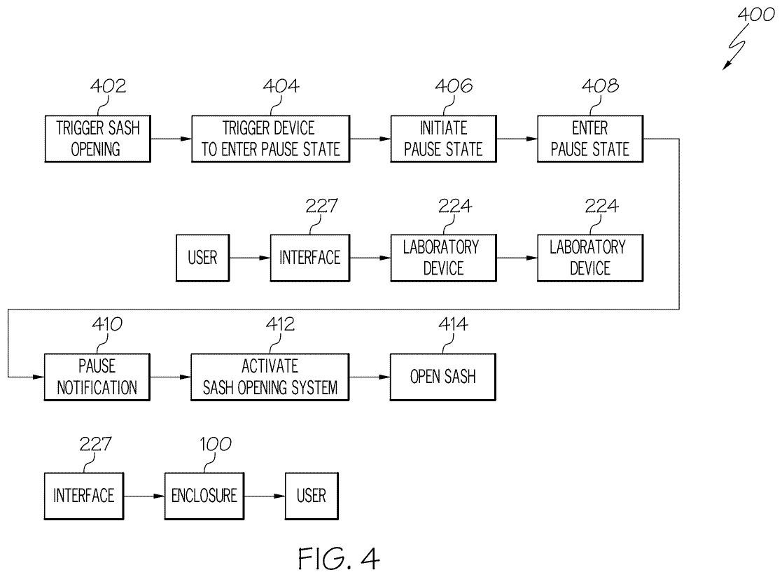

FIG. 4 is a flow diagram of a laboratory enclosure locking interlock process 400, in accordance with embodiments of the present inventive concept. In describing the process 400, reference is made to the control system 200 that can perform some or all of the process 400. Unlike the process 300 of FIG. 3, the locking interlock process 400 is required because a waiting period is required because the laboratory device 224 cannot abruptly stop, for example, a rotor or other moving part cannot stop rotating immediately due to its mechanical inertia that requires sufficient time for the laboratory device to stop operating. The locking process 400 prevents the access door from opening until the laboratory device stops operating, e.g., its rotor does not stop rotating.

At block 402, a user triggers the opening of the sash 108 to access the work surface 110. Unlike block 302 of FIG. 3 where the user opens the sash 108 which triggers the laboratory device 224 to enter a pause state, in block 402, the user sends a request to open the sash, e.g., from the user computer 210, which in turn triggers the laboratory device 224 to enter a pause state.

In response, at block 404, the enclosure triggers the laboratory device 224 inside the main enclosure 100 or the second enclosure 220 to enter the pause state. Accordingly, at block 406, the laboratory device 224 initiates the pause state. At block 408, the laboratory device 224 is placed in the pause state.

At block 410, the laboratory device 224 generates a notification that it is in the pause state, and outputs the notification to the controller 204, for example, via the physical connection 226 or API 222.

At block 412, the controller 204 processes the notification and activates an opening system, e.g., the motor 202 that actuates the sash 108. At block 412, the sash 108 is opened by the motor 202 so that the user can access the work surface 110. In doing so, the access door is unlocked so that a user can manually open the access door, or the access door is automatically opened by the motor 202 receiving instructions from the controller 204 after the determination is made that the laboratory device 224 is in the pause state, i.e., the rotor is not rotating, the robot arm is not articulating, etc. Unlike the process 300 of FIG. 3, the control in the process 400 of FIG. 4 is asynchronous. The external user sends a signal that it wants to access the sash 108. A processor of the laboratory device 224 acknowledges the request, then sends a request to the motor to stop its operation. When the motor no longer operates, rotates, articulates, or otherwise moves, e.g., which can be determined by a sensor 206, then the processor sends a signal to the controller 204 to unlock the sash 108 and notify the user that it is possible to access the workspace inside the laboratory device 224.

In embodiments, where the enclosure 100 has a button 103 for opening the sash 108, an external control feature, for example, stored as a web application at a smartphone or other remote mobile device can use the API 222 implemented at the laboratory device 224, which can emulate the physical activation of the button 103 in lieu of a user or robot physically present at the enclosure to select the actual button 103.

In some embodiments, the laboratory device 224 sends a signal via its API 222 to the controller 204 that it is no longer moving, followed by the controller 204 unlocking the sash 108 or sending a signal to the user's smartphone or computer 210 that it is now safe to open the sash 108. In other embodiments, the controller 204 automatically opens the sash 108 after it is safe to do so, i.e., after the laboratory device 224 is not moving or otherwise operational. Here, the API 222 may send a data command to the controller 204 to open the sash 108. If the call via API 222 is to put the device 224 on pause, for example, to access the workbench, then the sash 108 will remain closed. In both cases, the end of the procedure will be notified back using the API 222, since the external user computer 210 communicates with the laboratory device 224.

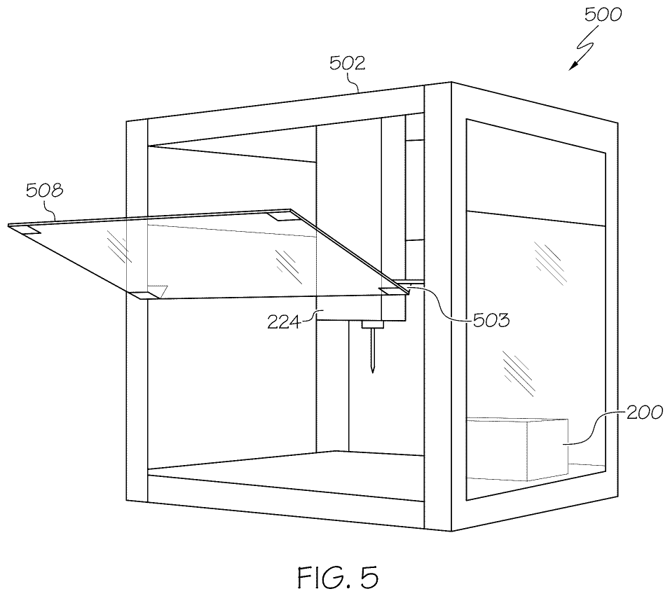

FIG. 5 is a perspective view of a liquid handling robot 500 in which embodiments of the present inventive concept can be implemented. The liquid handling robot 500 has an enclosure 502 and a sash 508 that pivots about a hinge 503 to transition from an open state (as shown) and a closed state. Other laboratory devices having an enclosed workbench or other embedded enclosure may equally apply in other embodiments.

In some embodiments, the liquid handling robot 500 includes the control system 200 of FIGS. 2 and 3, which are integral with the enclosure 502 of the liquid handling robot 500. The motor 202 of the control system 200 can communicate with the sash 508 to open or close the sash 508 according to control instructions received by the software interface from a remote user computer 210, for example, according to a scheduling application or other software application stored at and executed by the remote user computer 210. In some embodiments, the API 222 of the laboratory device 224 can be used to connect the remote user computer 110, or more specifically a scheduler executed by the remote user computer 110. The scheduler can be constructed and arranged to control a synchronization between a robotic arm external to the laboratory enclosure and the access door when in the open state receives the robotic arm. Accordingly, this can negate the need for a human operator to manually open and close the sash. This also covers a situation where a human user or robot desires to open the sash but is prevented because the sash is locked because the user or robot is not authorized to open the sash.

FIG. 6 is a perspective view of a laboratory enclosure 600 in which other embodiments of the present inventive concept can be implemented. Here, the liquid handling robot 500 is positioned in the laboratory enclosure 600. The operations described herein can be performed on both the sash 508 of the enclosure 502 and a sash 608 of the larger laboratory enclosure 600. Each enclosure 502, 600 may have a motor, controller, and software interface. In some embodiments, a single software interface is provided to communicate instructions from an remote user computer 210 to the electronic controller at each of the enclosures 502, 600, which can generate the control signals and governing the movement of their respective sash 508, 608. In some embodiments, each enclosure may have an access door such as a sash that is controlled. In other embodiments, only the larger laboratory enclosure 600 has an access door. In some embodiments, the software interface can provide instructions to open or close the sashes 508, 608 simultaneously. In some embodiments, the sash 608 of the larger laboratory enclosure 600 is controlled by a direct communication between the remote user computer 210 and the controller 204 of the control system 200. The liquid handling robot 500 having an integrated housing, or enclosure 502 may not have a sash, but has an opening for access. Although access through this opening may not be provided by a sash or the like, the sash 608 of the laboratory enclosure 600 in which the robot 500 is located may be used to prevent users from accessing the robot 500 while the robot 500 is in operation, and can be in an open state for access when the robot 500 is paused. In some embodiments, the sash 608 of the larger laboratory enclosure 600 is controlled by the liquid handling robot 500 inside the laboratory enclosure 600, which establishes when the sash 608 is in an open or closed state. For example, when the liquid handling robot 500 performs an operation, for example, transferring tubes of samples, the controller of the liquid handling robot 500 can exchange signals with the controller 204 of the control system 200 to lock the sash 608 that it cannot be opened during the operation. In some embodiments, the two enclosures 500, 600 may each have a motor, driver, software interface, and/or other components in communication with a common controller, for example, controller 204.

FIG. 7 is a perspective view of a laboratory enclosure 700 in which other embodiments of the present inventive concept can be implemented. Here, the enclosure 700 houses a laboratory device such as a liquid handling robot. The laboratory enclosure 700 is different than the enclosure 502 of FIG. 5, in which the enclosure 502 is part of, or integral with, the robot 500, while the robot in FIG. 7 is an add-on, or simply positioned in the interior of the enclosure 700. The external enclosure 502 of FIG. 5 requires an automated sash only. In FIG. 7, however, an automated sash is required only for the embedded enclosure of the laboratory device that can be automatically opened with an API.

FIG. 8 is a sequence diagram 800 for accessing a laboratory enclosure, in accordance with embodiments of the present inventive concept. The sequence diagram 800 may include one or more computer systems, including a client 802, a server 804, and a laboratory enclosure 806, for example, similar to a laboratory enclosure described in FIGS. 1-7. The client 802 may be similar to or the same as the user computer 210 of FIG. 2.

During operation, a user requests computer access to the enclosure 806. In doing so, the user initiates (812) a login request at the client 802. The client 802 may include an electronic display that displays a login page. Here, the user can enter credentials such as a username, password, and/or other security information. The server 804 processes (813) the user login information. The server 804 may include an authentication system 821 and database 822 for tracking the login information, e.g., an audit trail.

The user may send a request (814) from the client 802 to open the sash of the enclosure 806. In doing so, the client 802 may send the request with a user credential, for example, a personal identification. The personal identification may also be used in the login request at step 812. The server 804 processes (815) the request. The server 804 may access the database 822 for the audit trail information to authenticate the user credentials and determine whether to accept the request. If the user is authorized, then the server 804 sends a request (816) to the enclosure 806, e.g., via its API (816) the open sash request. The embedded software and hardware controller, e.g., similar to the controller 204 shown in FIG. 2, controls (817) a motor, internal robot, and/or other mechanical devices (not shown) inside the enclosure 806 to open the sash according to the user request.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A system for controlling access to an interior of a laboratory enclosure, comprising:
a motor in communication with an access door of the laboratory enclosure to transition the access door between an open state and a closed state, the access door exposing an opening to a work surface inside the laboratory enclosure in the open state and at least partially covering the opening in a closed state;
an electronic controller that generates control signals for the motor to transition the access door between the open state and the closed state; and
a software interface configured to provide a data instruction from an external computer to the electronic controller to generate the control signals and govern a movement of the access door between the open state and the closed state.

2. The system of claim 1, wherein the laboratory enclosure is a chemical or biological enclosure.

3. The system of claim 1, wherein the access door includes a mechanical sash.

4. The system of claim 1, wherein the software interface includes an application programming interface (API) that stores a security credential that is compared to a security credential provided by the external computer to determine whether to generate the data instruction.

5. The system of claim 1, further comprising at least one sensor that detects a position of the access door and sends position data to the electronic controller to automatically inactivate a device at the work surface when the at least one sensor detects the position of the access door between the open state and the closed state.

6. The system of claim 5, wherein the software interface receives a data request from the external computer for the access door to be opened, and the controller in response inactivates the device at the work surface inside the enclosure.

7. The system of claim 1, wherein the external computer stores and executes a software scheduler that controls a synchronization between a robotic arm external to the laboratory enclosure and the access door when in the open state receives the robotic arm.

8. The system of claim 1, wherein a transition from the closed state to the open state includes the electronic controller placing a device at the work surface in a pause state.

9. The system of claim 8, wherein the device is an automated liquid handling apparatus.

10. The system of claim 8, wherein the device includes a device enclosure, and the electronic controller controls access to the device enclosure inside the laboratory enclosure.

11. The system of claim 8, wherein the electronic controller communicates with the device by a physical connection of the device.

12. The system of claim 8, wherein the external computer communicates with the electronic device by a software connection of the electronic device, wherein the external device exchanges the control signals between the software connection of the electronic device and the electronic controller.

13. A laboratory enclosure, comprising:
a housing;
a motor in communication with an access door of the laboratory enclosure to transition the access door between an open state and a closed state, the access door exposing an opening to a work surface inside the laboratory enclosure in the open state and at least partially covering the opening in a closed state;
an electronic controller that generates control signals for the motor to transition the access door between the open state and the closed state;
a software interface configured to provide a data instruction from an external computer to the electronic controller to generate the control signals and govern the movement of the access door; and
an electronic device inside the housing that is controlled by the electronic controller commensurate with the open state and the closed state of the access door.

14. The laboratory enclosure of claim 13, wherein the housing is integral with the electronic device, and the controller places the electronic device inside the housing in a pause state to when transitioning the access door between the open state and the closed state.

15. The laboratory enclosure of claim 13, wherein the electronic device includes a device enclosure positioned in the housing, and the electronic controller controls access to the device enclosure inside the housing.

16. The laboratory enclosure of claim 13, wherein the electronic controller communicates with the electronic device by a physical connection of the electronic device.

17. The laboratory enclosure of claim 13, wherein the external computer communicates with the electronic device by a software connection of the electronic device, wherein the external device exchanges the control signals between the software connection of the electronic device and the electronic controller.

18. A laboratory device comprising:
a robotic liquid handling apparatus;
a housing about the robotic liquid handling apparatus having an opening for access to the robotic liquid handling apparatus;
an access door at the opening;
a motor in communication with the access door to transition the access door between an open state and a closed state, the access door exposing an opening to the robotic liquid handling apparatus inside the housing in the open state and at least partially covering the opening in a closed state;
an electronic controller that generates control signals for the motor to transition the access door between the open state and the closed state; and
a software interface configured to provide a data instruction from an external computer to the electronic controller to generate the control signals and govern a movement of the access door between the open state and the closed state.

19. The laboratory device of claim 18, wherein the electronic controller receives a user request to open the access door, determines whether the robotic liquid handling apparatus is operating, places the robotic liquid handling apparatus in a pause state, and unlocks the access door when the robotic liquid handling apparatus is in the pause state.

20. The laboratory device of claim 19, further comprising an authentication system in communication with a client device that outputs the user request with a unique personal identification, wherein the electronic controller unlocks the access door in response to the authentication system processing the user request and the unique personal identification.
